(19) United States
(12) Patent Application Publication
(10) Pub. No.: US 2006/0184596 A1
(43) Pub. Date: Aug. 17, 2006

(54) Fir filter device for flexible up-and downsampling

(76) Inventors: Guido Theodorus Gerardus Volleberg, Eindhoven (NL); Age Jochem Van Dalfsen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/550,878

(22) PCT Filed: Mar. 26, 2004
(86) PCT No.: PCT/IB04/50339

§ 371 Date: Sep. 27, 2005

(30) Foreign Application Priority Data
Mar. 31, 2003 (EP) 03100849.3

(51) Int. Cl. G06F 17/10

(52) U.S. Cl. 708/300

(57) ABSTRACT

A FIR filter includes an input pipeline IP with a sequence of input delay cells DI; each for storing an input sample, and a plurality of N input tap points TP. An output pipeline includes a sequence of output delay cells DO; each for storing a sample, a plurality of N summating elements Si for adding at least two samples, and an output switching network OSN for accumulating output values from the summating elements. A sequence of N taps T; are used for coupling the input pipeline to the output pipeline. Each tap includes a respective multiplier Mi for multiplying a sample from an input tap point by a coefficient. At least N−1 of the taps include a switching element for directing a sample from an input tap point through the multiplier to a summating element. The switching elements are arranged to enable supply of a sample from any tap point TPP to a summating element Si, where j<--i.

The invention relates to a Finite Impulse Response (FIR) filter device for sample rate converting a sequence of discrete representations and to an image display device including such a filter device.

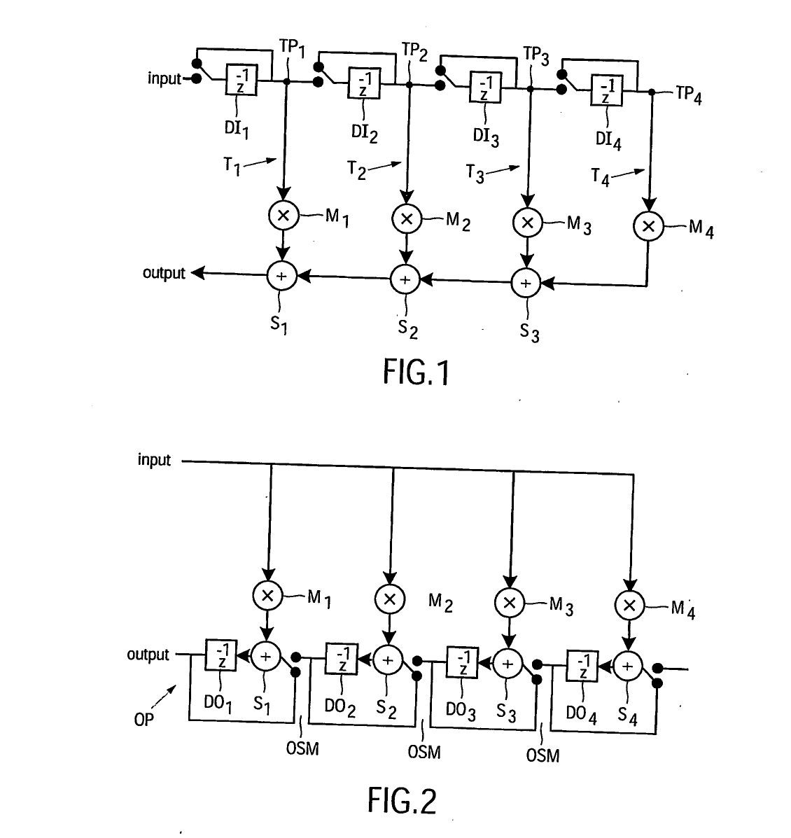

WO 98/19396 discloses a direct form, transposed form and combined FIR filter. FIG. 1 shows a representation of the known direct-form Finite Impulse Response (FIR) filter. The structure is output based. It incorporates an input pipeline IP with input delay cells DIᵢ. The input pipeline has a sequence of tap points TPᵢ. An input tap point TPᵢ is provided at least between each sequential pair of input delay cells DIᵢ and DIᵢ₊₁ and an input tap point is added after the last delay cell. An output line of the filter supplies a sequence of output discrete representations. The output line includes a plurality of summating elements Sᵢ for adding at least two discrete representations. The discrete representation is, typically, a sample such as a video pixel. Taps Tᵢ couple a respective input tap point TPᵢ to a corresponding summating element Sᵢ. Each tap Tᵢ includes a respective multiplier Mᵢ for multiplying a discrete representation from the input pipeline by a coefficient. The delay cells ensure that the multipliers operate on a set of successive input samples in one clock cycle. The multipliers can multiply an input sample with a filter value reflected by the coefficient fed to the multiplier (not depicted here). In the example of FIG. 1, four input samples can contribute to one output sample. In a situation where for each input sample an output sample is generated this enables filtering with a footprint (or filter width) of four samples. This filter structure is also capable of scaling an input signal. An example is up-scaling of a video signal where a line of video output samples contains more samples than the input line. To this end, the filter is driven by the output clock. By operating on the same input samples during more than one cycles more output samples than input samples are produced (i.e. the signal is up-scaled). Shifting of the input samples through the input delay cells is controlled by an input enable signal (no shown). For up-scaling, during some output clock cycles shifting of the input is disabled. When the input shifting is disabled, it is still possible to supply other coefficients to the multiplexer. In this way, successive output samples derived from the same group of input samples can be different. Such a filter is usually referred as a poly-phase filter. In principle, the filter can also be used for downscaling, where the output contains fewer samples than were input to the filter. This may result in a situation where more input samples would be required than fit into the input pipeline, degrading the quality of the filtering. To overcome this, more delays and multiplier/adders may be added, increasing the cost of the filter. The transposed filter is more suitable for downscaling.

FIG. 2 shows a representation of the known transposed-form FIR filter. The structure is output based. It includes an output pipeline OP with a sequence of output delay cells DOᵢ, each for storing a discrete representation (sample). In between each sequential pair of output delay cells DOᵢ and DOᵢ₊₁ is a summating elements Sᵢ for adding two samples. The summating element Sᵢ receives one of the samples from the input line, through a respective multiplier Mᵢ. The other sample is selected from a preceding delay cell DOᵢ₊₁ or an output switching network OSN for accumulating output values from the summating elements. In this filter, all multipliers operate on a single input sample. The pipeline accumulates the multiplied input samples for each output sample. The output switching network allows the result of more multiplicator steps to be added to a single output sample (in a manner similar to when no new input sample is shifted into the regular filter structure). This structure is optimal for down scaling, where the filter is driven by the input clock. As many input samples can be added to a single output sample as necessary. Thus any downscale ratio can be chosen. During normal filtering the output switching network is in the pass-through position, where each summating element receives the delayed output of the preceding summating element (with the exception of D04 that receives a ‘zero’ sample value). In the example of FIG. 2 the filter width is four. During downscaling the output switching network is used in feedback mode. In this way the multiplied inputs are added to the 4 (=filter width) accumulating output samples. It will be appreciated that this structure is less suitable for high-quality up-scaling, unless more multipliers/adders/delays were added.

To be able to deal with different scaling requirements, WO 98/19396 also shows a filter that is a combination of the described direct and transposed filters. In the combined filter, the multipliers are shared. Selectors are used to set the filter in an up-scaling mode or downscaling mode. During upscaling the filter operates like the direct form filter and only the delay elements of the input pipeline are used. During downscaling, the filter operates like a transposed form filter and only the delay elements of the output pipeline are used.

With the introduction of 16:9 television sets, with most material having a 4:3 aspect ratio, high quality display of this material became more important. Up-scaling a 4:3 format to the 16:9 format (using a fixed ratio) resulted in wide faces which was unacceptable. It was desired to use variable scaling, referred to as panorama mode. In this mode, the parts of the image that are displayed on the sides of the screen are up-scaled. The part of the image displayed in the center of the screen was not up-scaled. The known filter is capable of performing such scaling. It was found that even better results were achieved if the center of the screen was downscaled (for compensation). A possible scaling curve is a parabola (a polynomial of second degree) allowing both upscale and downscale ratios within one video line. Using the known combined filter structures results in a delay when a change-over between the filters occurs, due to the fact that the pipeline that was not used before the change-over needs to be re-filled with the desired samples. Such a delay is undesired for stream processing of, for example, video or audio.

It is an object of the invention to provide a filter structure that is capable of high-quality filtering, capable of scaling streamed data, with a smooth change-over between scaling modes.

To meet the object of the invention, the filter device includes:
an input pipeline IP for receiving the sequence of discrete representations and including a sequence of input delay cells DIᵢ, each for storing a discrete representation; and a plurality of N input tap points TPᵢ, where an input tap point is provided at least between each sequential pair of input delay cells;
an output pipeline for supplying a sequence of discrete representations and including a sequence of output delay cells DOᵢ, each for storing a discrete representation; a plurality of N summating elements Sᵢ for adding at least two discrete representations, a summating element being provided at least between each sequential pair of output delay cells; and an output switching network OSN for accumulating output values from the summating elements; and
a sequence of N taps Tᵢ for coupling the input pipeline to the output pipeline; each tap including a respective multiplier Mᵢ for multiplying a discrete representation from an input tap point by a coefficient; at least N−1 of the taps including a switching element for directing a discrete representation from an input tap point through the multiplier to a summating element; the switching elements being arranged to enable supply a discrete representation from any tap point TPⱼ to a summating element Si, where j<=i.

The arrangement of the taps enable the filter to access multiple elements from both the input pipeline and the output pipeline simultaneously. This makes it possible to maintain a high-quality filtering performance also during a change-over from up-scaling to down-scaling or vice versa.

According to the measure of the dependent claim 2, each of the taps Tᵢ are coupled to only one respective summating elements Sᵢ; the switching element SWⱼ being provided in between tap points TPᵢ, where j<=i and the multiplier Mᵢ. In principle, the switching element may also be located in between the multipliers and the output pipeline. This merely changes the respective multiplication coefficient out off the matrix Ci.

According to the measure of the dependent claim 3, the FIR filter device has a constant filter width N, N output delay cells DOᵢ, and N or N−1 (depending on if the input stream can be stalled) input delay cells DIᵢ. In this arrangement a filter width of at least N can be achieved during downscaling, up-scaling, also when the scaling factor or scaling mode is changed.

According to the measure of the dependent claim 4, the input pipeline includes an input switching network for accumulating input values in the input delay cells DIᵢ, enabling upscaling in situations where the input stream can not be temporarily halted while output samples are generated at a higher frequency.

According to the measure of the dependent claim 5, each multiplier Mi is associated with a respective coefficient matrix Cᵢ to enable poly-phase filtering.

According to the measure of the dependent claim 6, the filter device includes a controller operative to control the filter device based on a state machine. In principle, many settings of the filter can be changed. Using a state machine is an effective way to control the scaler settings.

According to the measure of the dependent claim 7, the state machine determines at least one of the following:
a setting of the switching elements SWi,
a setting of the output switching network,
clocking of the input pipeline and/or output pipeline.

Depending on the functionality of the filter, the state machine also determines a selection of a coefficient from the coefficient matrix Cᵢ and/or a setting of the input switching network.

According to the measure of the dependent claim 10, the filter device includes a further delay element and a subtracting element for subtracting an input discrete element from an immediately preceding input discrete element and supplying an outcome of the subtraction into the input pipeline; and including a further summating element for adding the immediately preceding input discrete element to an output discrete element to be supplied by the output pipeline. In this way the filter operates on ‘AC’ values (i.e. on a difference with respect to the previous input sample instead of the absolute value). This avoids the so-called DC-ripple. Such a ripple occurs where the input is more or less constant (‘DC’) and the coefficients applied to the filter do not exactly add up to a multiplication factor of 1, causing a small disturbance being added. Where small sequences of constant values are interchanged with a different sample value this may result in a visible or in any other way noticeable ‘ripple’ in the output signal for the filter. By operating on an offset instead of an absolute value, the filter is fed with zero-value samples for sequences of constant sample values. Such a sequence will result in a zero output of the multipliers, irrespective of small faults in the multiplication factors. The actual input sample is added at the output of the filter.

To meet an object of the invention, a signal processing apparatus includes a FIR filter device as claimed in claim 1 for sample rate converting an input signal, where the discrete representation is a sampled input signal, for subsequent rendering by a rendering device.

These and other aspects of the invention are apparent from and will be elucidated with reference to the embodiments described hereinafter.

In the drawings:

FIG. 1 shows a prior art direct form FIR filter;

FIG. 2 shows a prior art transposed form FIR filter;

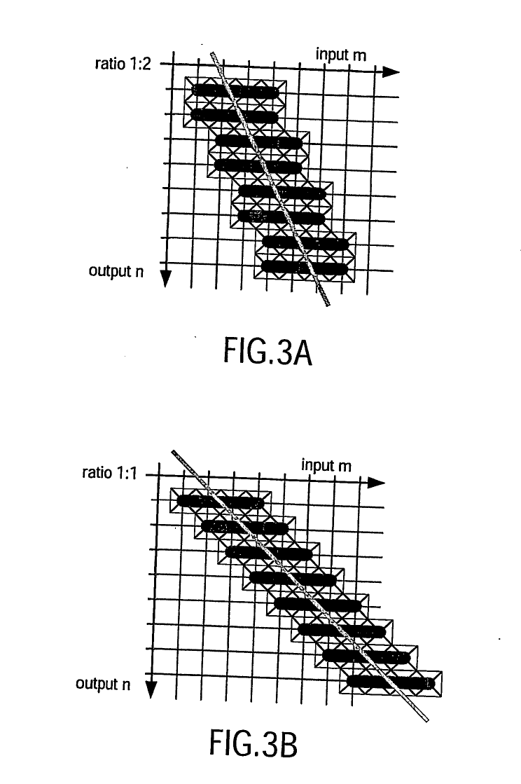

FIG. 3 shows upscaling using a direct form FIR filter;

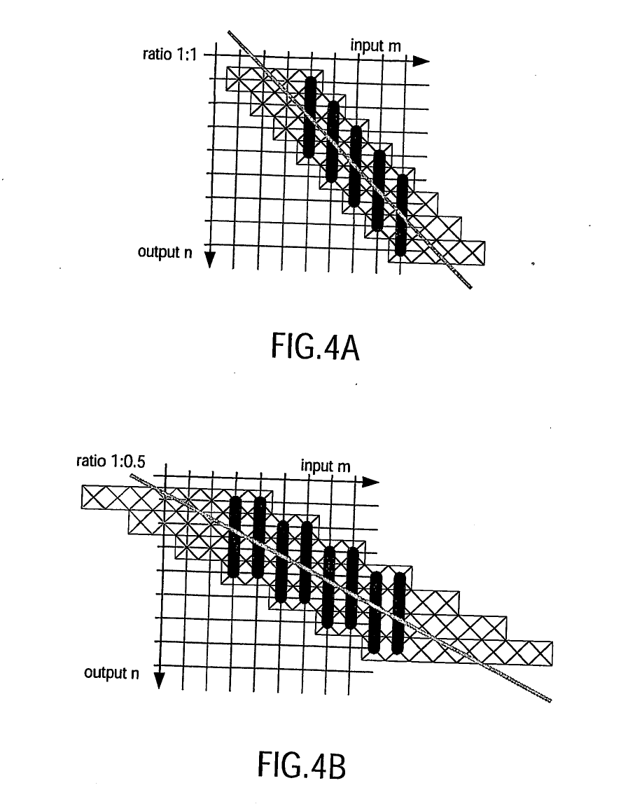

FIG. 4 shows downscaling using a transposed form FIR filter;

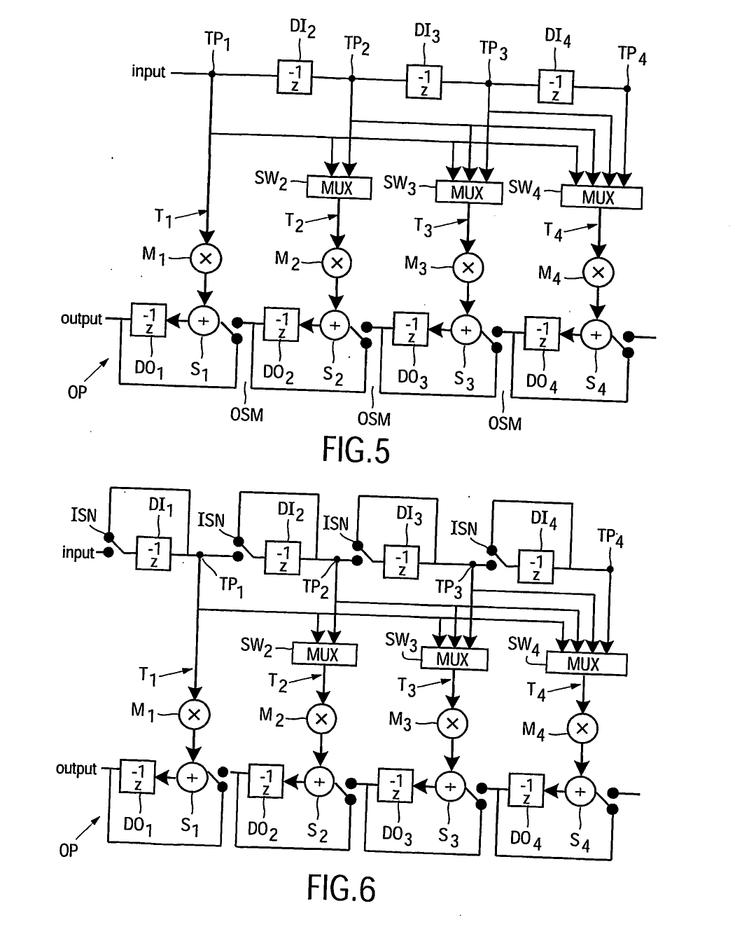

FIG. 5 illustrates a FIR filter according to the invention;

FIG. 6 shows a first embodiment of the filter;

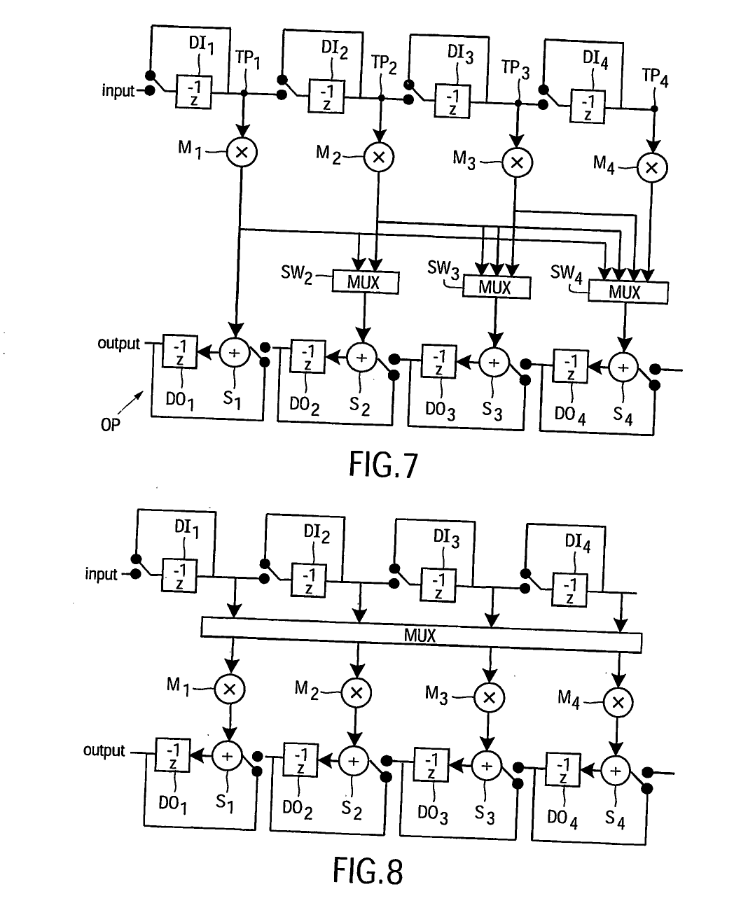

FIG. 7 shows a second embodiment of the filter;

FIG. 8 shows a third embodiment of the filter;

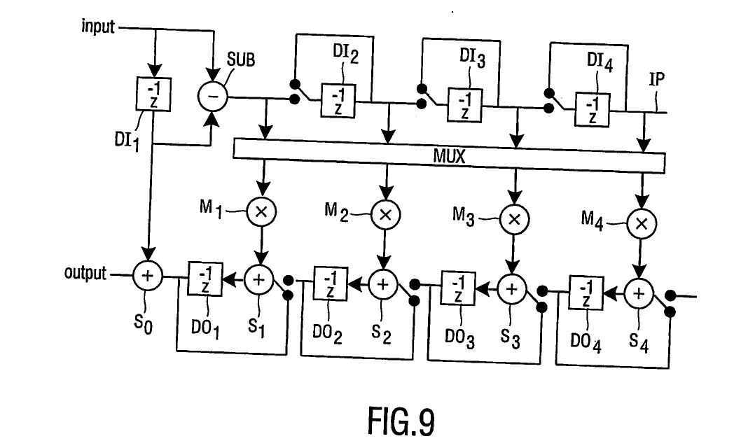

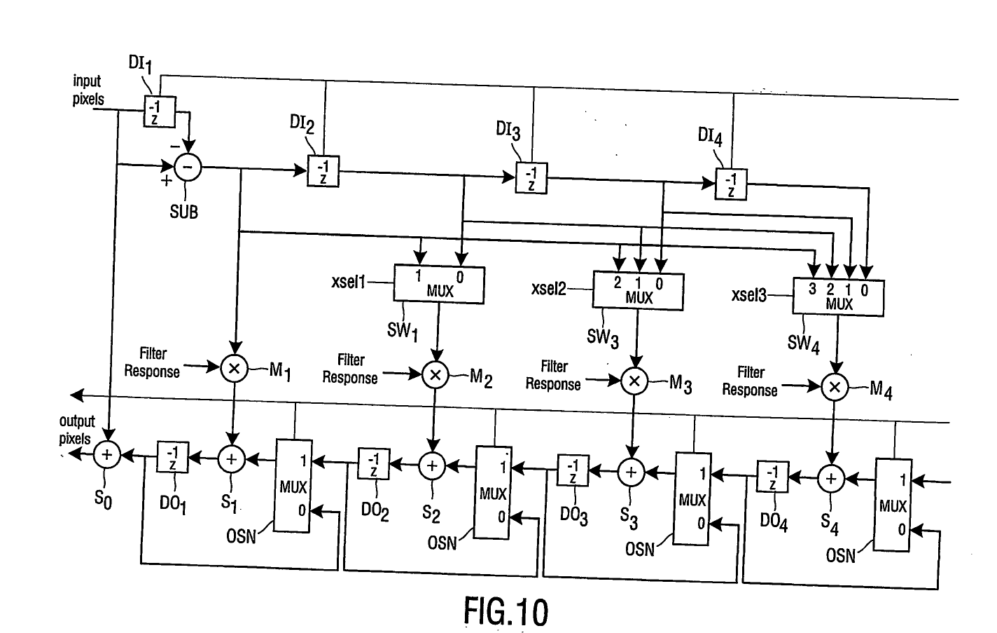

FIG. 9 shows a fourth embodiment of the filter;

FIG. 10 shows more details of an embodiment of the filter;

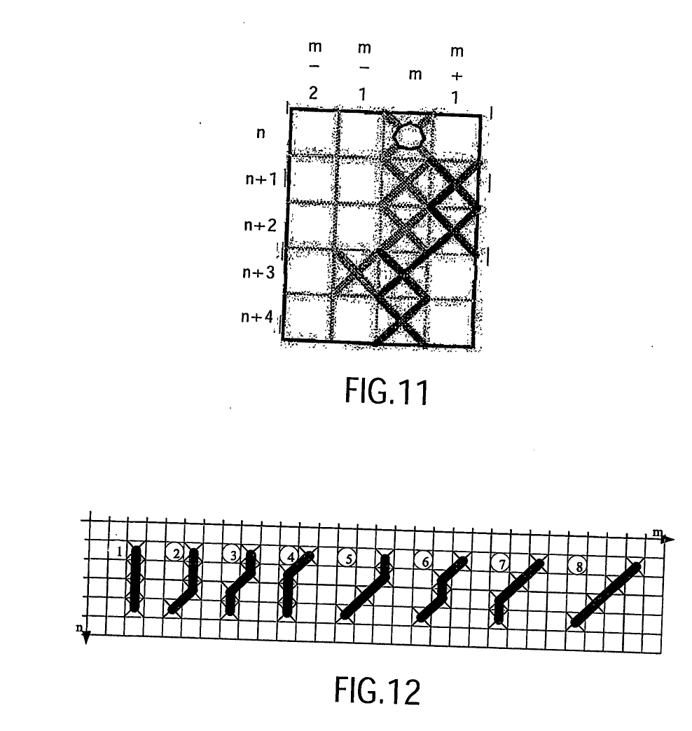

FIG. 11 shows the way of indicating which samples are added to the output pipeline;

FIG. 12 illustrates the states of a four-stage filter;

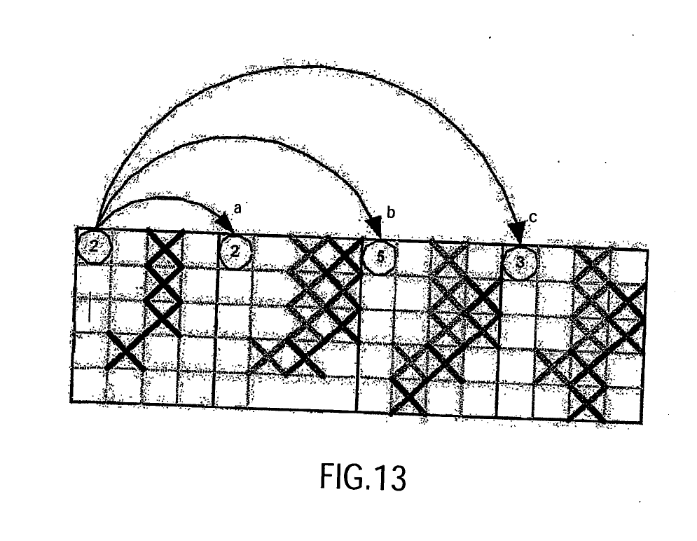

FIG. 13 illustrates state transitions for state 2;

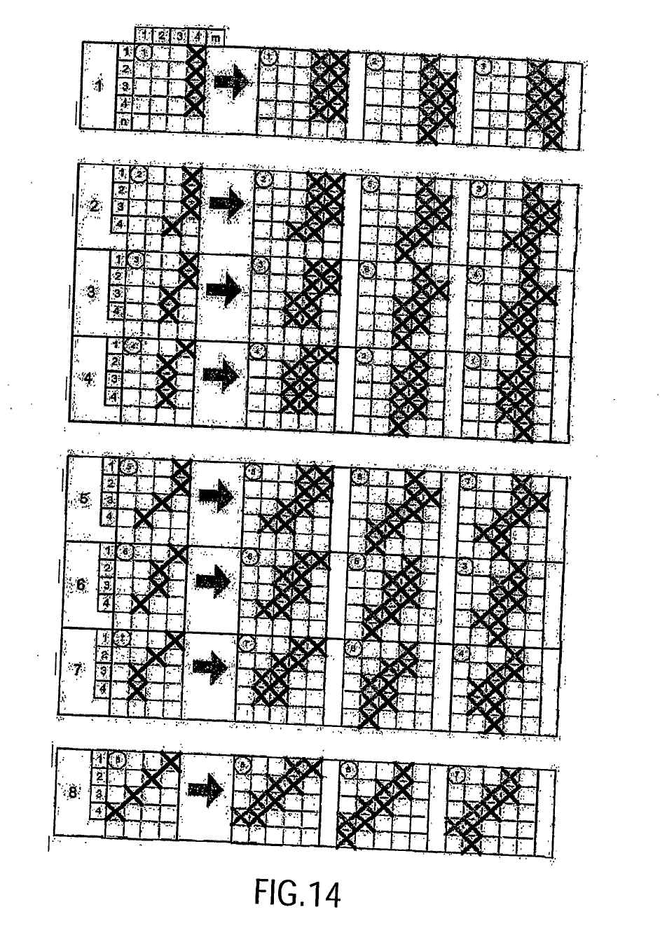

FIG. 14 shows the states and transitions for a four-stage filter;

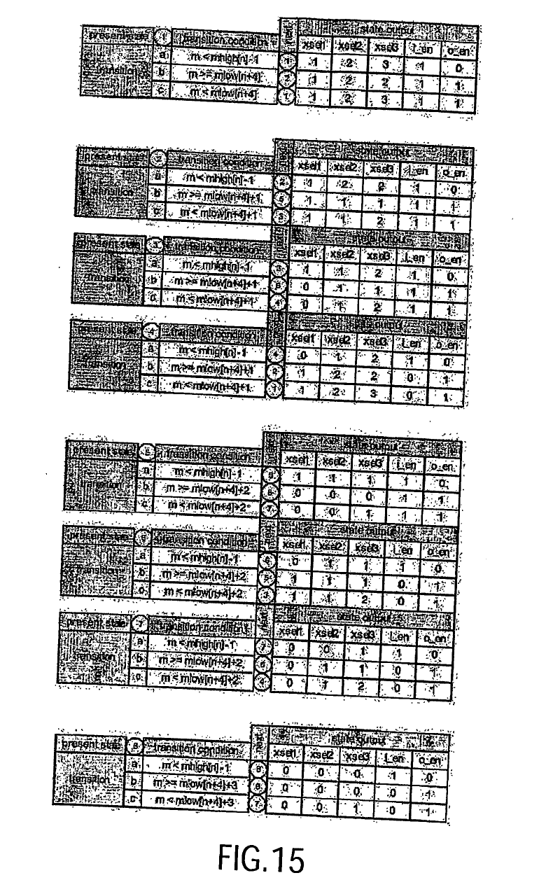

FIG. 15 shows the conditions for the transitions and the output;

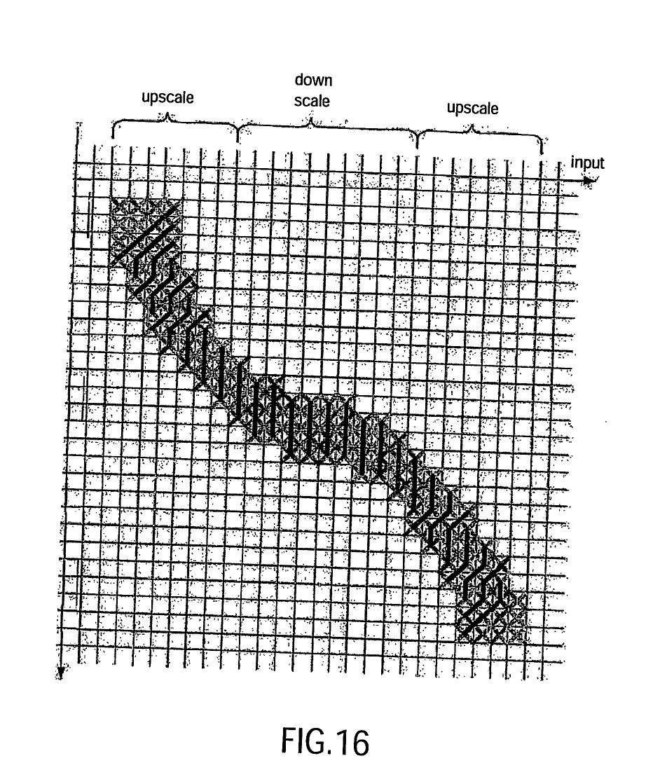

FIG. 16 gives an example of a panorama processing of a sample line; and

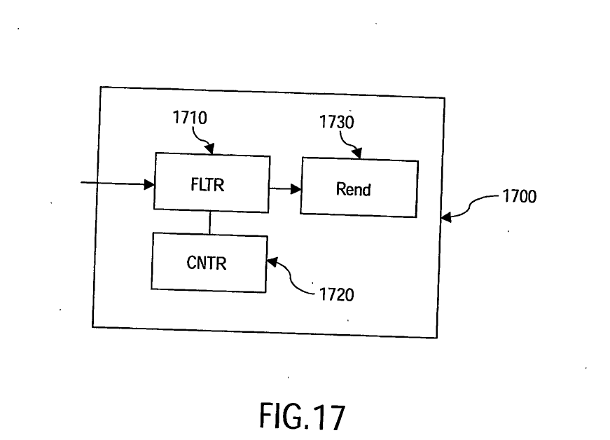

FIG. 17 shows a signal processing apparatus including the filter according to the invention.

To prevent long pipelines of either input samples or output samples optimal structures are developed for filtering in hardware. For upscaling, this is the prior art direct form filter of FIG. 1. In one clock cycle, several input samples are added to a single output sample (input sample pipelining). FIG. 3 illustrates this in the form of showing which samples, input for output, are computed in each clock. In the example of FIG. 3, the filter width (hereinafter FW) is four: an output sample receives a contribution from four input samples. Using a ratio of 1:1 (illustrated in FIG. 3B), each time an output sample is generated the input samples are also shifted one position. Using an upscaling ratio of 1:2 (FIG. 3A), every two output samples the input samples are shifted one position. In FIG. 3, horizontally the input sample number is indicated, and vertically the output sample number is indicated.

For downscaling, the transposed filter of FIG. 2 can be used. FIG. 4 illustrates the working of this filter using vertical lines. Each clock computes the contribution of a single input sample to more output samples (output sample pipelining). Also in this fig. a FW of four is shown: an input sample contributes to four output samples. Using a ratio of 1:2 (FIG. 4B) means that an output sample has received a contribution from eight input samples in total at the moment it is being output from the filter. With a ratio of 1:1 (FIG. 4A) means that an output sample has received a contribution from four input samples in total at the moment it is being output from the filter.

If either type of filter is applied in the other situation more multipliers than required for the filter width would be needed if quality was to be maintained.

FIG. 5 illustrates a first embodiment according to the invention that supports flexible high quality up and down scaling. The number of samples operated on in a cycle of the filter is equal to FW irrespective of upscaling or downscaling. Applications are seamless switching for a variable scaling ratio (up- and downscaling). The filter is output (clock-) driven for upscaling and input (clock-) driven for downscaling. Consequently, the filter has a fixed number of multiplications per clock, which is beneficial in Hardware (HW). Using the same reference signs as for FIGS. 1 and 2, the filter includes an input pipeline IP with input delay cells DIᵢ (in the example 3 input delay cells are shown). The input pipeline has a sequence of tap points TP_{L} (in the example, four tap points are shown). An input tap point TPᵢ is provided at least between each sequential pair of input delay cells DIᵢ and DIᵢ₊₁. The filter further includes an output pipeline OP with a sequence of output delay cells DOᵢ, each for storing a discrete representation (sample) (shown are four output delay cells). In between each sequential pair of output delay cells DOᵢ and DOᵢ₊₁ is a summating elements Sᵢ for adding two samples. The summating element Sᵢ receives one of the samples from a preceding delay cell DOᵢ₊₁ or an output switching network OSN for accumulating output values from the summating elements. The output pipeline accumulates multiplied input samples for each output sample. The output switching network allows the result of more multiplicator steps to be added to a single output sample (in a manner similar to when no new input sample is shifted into the regular filter structure). The input pipeline and the output pipeline are coupled via sequence of N (FW) taps Tᵢ. Each tap includes a respective multiplier Mᵢ for multiplying a discrete representation from an input tap point by a coefficient. At least N−1 of the taps include a switching element for directing a discrete representation from an input tap point through the multiplier to a summating element in the output pipeline. The switching elements enable supply of a discrete representation from any tap point TPⱼ to a summating element Si, where j<=i. FIG. 5 shows three switching elements SW₂, SW₃, and SW₄. Switching element SWi is part of tap Tᵢ and allows an input sample to be selected from tap point T₁ up to and including Tᵢ. So, SW₁ only needs to enable selection of one sample (the one available via TP1) and is, therefore, not shown.

FIG. 6 shows a further embodiment, wherein the input pipeline IP includes a input switching network ISN for stalling input values in the input delay cells DIi. This enables upscaling in situations where the input stream can not be temporarily halted while output samples are generated at a higher frequency.

In the embodiments shown in FIGS. 5 and 6, the switching elements are located in between the input tap point and the multipliers. In principle, the switching elements may also be located in between the multipliers and the summating elements. This is illustrated in FIG. 7, which in other aspects corresponds to FIG. 6.

FIG. 8 shows an alternative embodiment where the switching elements SWi are integrated into a switching network (multiplexing layer, indicated as MUX) that may support more switching options than required.

FIG. 9 shows a further embodiment including a delay element DI₁ and a subtracting element SUB. The current input sample and the immediately preceding input sample (supplied by the delay cell DI₁) are subtracted from each other. The outcome of the subtraction is fed into the input pipeline IP. In this way, the filter does not operate on absolute sample values but on relative sample values. In particular, if the input signal is constant for a certain sequence of input samples (a DC signal) the core filter will provide a ‘0’ output In the embodiment of FIG. 9 the delayed input element is subtracted from the current input sample. An absolute input sample is added to the output of the output pipeline to give the actual output sample, using a summating element S₀. In FIG. 9, the input sample stored in delay element DI₁ is added to the output sample. In an alternative embodiment shown in FIG. 10 the current input sample is added to the output sample. It will be appreciated that in the embodiments of FIGS. 9 and 10, the main purpose of DI₁ is to create a relative input signal. A further input delay element may be added to the input pipeline to complete the input switching network. This additional input delay element including feedback switch can be the same as shown for DI₁ to DI₄ of FIG. 6. It would be positioned after the input subtractor SUB and before the first tap T₁.

FIG. 10 provides more details of the filter as shown in FIG. 9 with the switching elements of FIGS. 5 and 6. It shows that filter coefficients are supplied to the multipliers Mᵢ. Preferably, each multiplier Mᵢ is associated with a respective coefficient matrix Cᵢ to enable poly-phase filtering. For each filter phase, a different coefficient can be supplied to the multiplier for multiplication with an input sample. In itself, poly-phase filtering is known and will not be described further.

In a preferred embodiment, the FIR filter device according to the invention includes a controller for controlling the filter device based on a state machine. The state machine may control any (preferably all) of the following aspects:

clocking of the input pipeline and/or output pipeline (via an input enable and output enable signal, respectively),

selection of a coefficient from the coefficient matrices Cᵢ, and/or

a setting of the switching elements SWᵢ (via a respective xselᵢ signal),

a setting of the output switching network OSN,

a setting of the input switching network ISN.

FIG. 10 also provides more details of the control of the filter. The main task of the state machine is to determine the multiplications that need to take place for each clock cycle. In this way, pipeline run-in and run-out effects are avoided. The state machine will be described in detail for a filter width of 4. Persons skilled in the art will be able to design a state machine for any desired filter width based on the same principles. The working of the state machine will be explained with reference to FIGS. 11 to 16. FIG. 11 illustrates how in FIG. 12 it is indicated which samples are added to the output pipeline. As for FIGS. 3 and 4, horizontally the input samples are shown and vertically the output samples. FIG. 11 shows two cycles of the filter. In the first cycle, input sample m is added to the outputs n, n+1 and n+2, and input sample m−1 is added to output sample n+3. During the second cycle, input sample m+1 is added to output samples n+1 and n+2, and input sample m is added to output samples n+3 and n+4.

FIG. 12 shows that the state machine has eight states for a filter width of 4. State 1 represents the normal transposed way, a single input sample is mapped onto FW output samples, corresponding to FIG. 5. State 8 represents the case wherein FW input samples are mapped onto FW output samples. Since the pipelined input and output samples have the restriction that they are consecutive, the number of possibilities can be mathematically computed. Each consecutive multiplication a multiplier operates on either the same input sample or the previous one (2 choices) and thus never ahead. The first multiplier does not have a choice; it always operates on the current input sample. Since FW equals four in this case there are 3 (FW minus one) multiplications which can be either one of the two choices given. This results in 2 to the power of 3 equals 8 possibilities. In general, for FW=n a total of 2^{(FW-1)} states are used. Thus, increasing FW results in an exponential increase of the number of possibilities (i.e. the number of distinct states). Referring the FIG. 5, this can also be illustrated as follows. Multiplier M₁ always receives the input from tap point TP₁ (no choice). Multiplier M₂ can selectively receive an input sample from TP₂ (i.e. the previous input sample) or TP₁ (i.e. the current input sample). So, two choices. In theory, multiplier M₃ can selectively receive an input sample from TP₃, TP₂, or TP₁. However, it is desired that the filter operates on a consecutive sequence of input samples, no ‘holes’ should occur (e.g. sample 1, 2, and 4 contribute to an output of the filter, but sample 3 was skipped). This implies that the choice of M₃ is limited to the sample preceding the one currently being selected for M₂ or the same one as being selected for M₂. Similarly, M₄ has a theoretic choice of four input samples, but is practically limited to the same one or the previous input sample (also two choices).

Since the cases are fixed for any predetermined FW it is most feasible to implement this in a finite state machine (FSM). Each state is followed either by itself or by another state so rules can be set up on state transitions. As will be described in more detail below, the transitions depend on the on forehand computed m_{low} and m_{high} of the output samples.

FIG. 13 illustrates the state transitions for state 2. In every state, like state 2, three different transitions are possible (indicated as a, b and c). Transition a is done under the condition that the output sample is not finished (as will be described below: m_{high} has not been reached). In this case the state remains the same, a new input sample is requested, no new output sample. Transitions b or c are done if m_{high} has been reached, so not state a. The decision for b or c depends on m_{low} of the new output sample. In each of these two transitions apart from processing a new output sample also a new input sample is requested (this is not generally the case). FIG. 13 shows the current state (in this example state 2) as the left block. The three other blocks show the state that is reached after transition a, b, or c, respectively. For each block the state number is indicated in the upper left corner. So, FIG. 13 shows the following state transitions:

a: 2−>2

b: 2−>5, and

c: 2−>3.

Using this notation no arcs need to be shown, although in FIG. 13 they are shown to illustrate the principle. FIG. 14 shows all transitions for all eight states.

The state machine's output controls the scaling engine topology (which input samples contribute with which entry of the filter table to which output sample including the request of new input samples and shifting out ready computed output samples. FIG. 15 shows for each state the condition for any of the three possible state transitions, and the resulting output. In this example, the state machine controls the switching elements SWᵢ via the respective signals xselᵢ (as also shown in FIG. 10), clocking the input pipe line, via signal input-enable i_en, and clocking of the output pipeline via signal output-enable o_en.

FIG. 16 gives an example of a panorama processing of one sample line. The first input samples are upscaled. For successive sample, the ration is slowly adjusted to 1:1, followed by downscaling in the center. Then the reverse process occurs: the ration is again slowly adjusted to 1:1, followed by upscaling. This process may be controlled by any suitable scaling curve, such as a parabola

Each output sample receives a contribution from several input samples multiplicated with a filter coefficient. The first sample to contribute is indicated with m_{low}, the last with m_{high}. All samples in between also contribute thus m_{low} and m_{high} bounds the set of input samples for a specific output sample. As discussed before the distance between m_{low} and m_{high} needs not to be constant e.g., flexible (downscale) scaling ratio. The scaling ratio thus reflects itself on the distance of m_{low} and m_{high} with a given FW.

FIG. 17 shows a signal processing apparatus 1700 that includes the FIR filter device 1710 for sample rate converting an image signal, such as an audio or video signal. The discrete representations on which the filter operates are sampled input image signals. The image signal may already be supplied in a suitable digital form to the display apparatus. If the signal is provided in an analogue form, the display apparatus may include an A/D converter for sampling the analogue signal. A controller 1720 is used for controlling the filter, as described above. The controller 1720 may be embedded in the filter device or may be external to the filter device (e.g. being executed on suitable processor of the signal processing apparatus. The sample rate converted signal may be output for further processing by other apparatuses. In the latter case, the signal may be output in a suitable digital representation via a suitable digital interface. Such representations and interfaces are well known. It may also be converted to an analogue form using a D/A converter. The sample rate converted signal may be further processed by the signal processing apparatus itself. For example, the signal processing apparatus may include a storage device for storing the converted signal. The storage may, for example, be a tape, hard disk, or solid state memory. The signal may be provided from the storage to a rendering device. The rendering device may be external or internal to the signal processing apparatus. The rendering device may, for example, be a display device 1730, such as a CRT, LCD, plasma display or a suitable other display, or an audio rendering device (amplifier 1740 and speakers 1750).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and “include” and its conjugations do not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. A computer program product may be stored/distributed on a suitable medium, such as optical storage, but may also be distributed in other forms, such as being distributed via the Internet or wired or wireless telecommunication systems. In a system/device/apparatus claim enumerating several means, several of these means may be embodied by one and the same item of hardware. The mere fact that certain measures are recited in mutually different dependent claims does not indicate that a combination of these measures cannot be used to advantage.

1. A Finite Impulse Response (FIR) filter device for sample rate converting a sequence of discrete representations; the filter device including:
an input pipeline IP for receiving the sequence of discrete representations and including:
a sequence of input delay cells DIᵢ, each for storing a discrete representation; and
a plurality of N input tap points TPᵢ, where an input tap point is provided at least between each sequential pair of input delay cells;
an output pipeline for supplying a sequence of discrete representations and including:
a sequence of output delay cells DOᵢ, each for storing a discrete representation;
a plurality of N summating elements Sᵢ for adding at least two discrete representations, a summating element being provided at least between each sequential pair of output delay cells; and
an output switching network OSN for accumulating output values from the summating elements; and
a sequence of N taps Tᵢ for coupling the input pipeline to the output pipeline; each tap including a respective multiplier Mᵢ for multiplying a discrete representation from an input tap point by a coefficient; at least N−1 of the taps including a switching element for directing a discrete representation from an input tap point through the multiplier to a summating element; the switching elements being arranged to enable supply of a discrete representation from any tap point TPⱼ to a summating element Si, where j<=i.

2. A FIR filter device as claimed in claim 1, wherein each of the taps Tᵢ are coupled to only one respective summating elements Sᵢ; the switching element SWᵢ being provided in between tap points TPⱼ, where j<=i and the multiplier Mᵢ.

3. A FIR filter device as claimed in claim 1, having a constant filter width N, N output delay cells DOᵢ, and N or N−1 input delay cells DIᵢ.

4. A FIR filter device as claimed in claim 1, wherein the input pipeline includes a input switching network ISN for accumulating input values in the input delay cells DIᵢ.

5. A FIR filter device as claimed in claim 1, wherein each multiplier Mᵢ is associated with a respective coefficient matrix Cᵢ to enable poly-phase filtering.

6. A FIR filter device as claimed in claim 1, including a controller operative to control the filter device based on a state machine.

7. A FIR filter device as claimed in claim 1, wherein the state machine determines at least one of the following:
a setting of the switching elements SWi,
a setting of the output switching network,
clocking of the input pipeline and/or output pipeline.

8. A FIR filter device as claimed in claim 5, wherein the state machine determines selection of a coefficient from the coefficient matrix Cᵢ.

9. A FIR filter device as claimed in claim 4, wherein the state machine determines a setting of the input switching network.

10. A FIR filter device as claimed in claim 1, including a further delay element and a subtracting element for determining a difference between an input discrete element and an immediately preceding input discrete element and supplying the difference into the input pipeline; and including a further summating element for adding input discrete element or the immediately preceding input discrete element to an output discrete element to be supplied by the output pipeline.

11. A signal processing apparatus including a FIR filter device as claimed in claim 1 for sample rate converting an input signal, where the discrete representation is a sampled input signal, for subsequent rendering by a rendering device.

12. A signal processing apparatus as claimed in claim 11, wherein the signal processing apparatus includes the rendering device.
